(19) United States
(12) Patent Application Publication
(10) Pub. No.: US 2025/0012244 A1
(43) Pub. Date: Jan. 9, 2025

(54) MOTORCYCLE AIRCLEANER

(71) Applicant: KAWASAKI MOTORS, LTD., Hyogo (JP)

(72) Inventor: Ayumi HAMADA, Hyogo (JP)

(73) Assignee: KAWASAKI MOTORS, LTD., Hyogo (JP)

(21) Appl. No.: 18/218,151

(22) Filed: Jul. 5, 2023

(51) Int. Cl. F02M 35/024; F02M 35/02; F02M 35/16

(52) U.S. Cl. CPC F02M 35/02416; F02M 35/0202; F02M 35/162

(57) ABSTRACT

An air cleaner filters intake air to be supplied to an engine of a motorcycle. The air cleaner includes: a cleaner case having an interior and having an opening defined therein; a filter unit which filters intake air therethrough and is detachably mounted to the cleaner case; and a pair of guides which guide a peripheral edge of the filter unit which is positioned opposite thereto to let the filter unit slide thereon into the interior of the cleaner case through the opening.

### BACKGROUND OF THE INVENTION

### Field of the Invention

The present disclosure relates to an air cleaner for purifying intake air to be supplied to an engine of a motorcycle.

### Description of Related Art

An air cleaner for a motorcycle includes a cleaner case and a filter unit which is detachably mounted to the cleaner case to provide for the filtering of intake air. The filter unit is taken out of the cleaner case at regular intervals or as necessary for cleaning or replacement purposes.

Typically, the filter unit is mounted to the cleaner case with fasteners such as a bolt. To dismount the filter unit from the cleaner case, an operator will put his hands into the cleaner case, carrying a tool, through an opening formed in the cleaner case and loosen the fasteners by using the tool, so that the filter unit can, then, be taken out through the opening. Conversely, to mount the filter unit to the cleaner case, an operator will put his hands into the cleaner case through the opening while carrying the filter unit, the fasteners, and the tool, and the tool is used to mount the filter unit to the cleaner case. This meant that the mounting and dismounting of the filter unit to/from the cleaner case were often time- and labor-intensive, thus, leading to poor maintainability.

### SUMMARY OF THE INVENTION

The present disclosure is directed to providing a motorcycle air cleaner, which has an enhanced maintainability and enables easy mounting and dismounting of a filter unit thereof.

In order to achieve this object, the present disclosure provides an air cleaner which filters intake air to be supplied to an engine of a motorcycle, the air cleaner including: a cleaner case having an interior and having an opening defined therein; a filter unit which filters intake air therethrough, having a peripheral edge, and being detachably mounted to the cleaner case; and a pair of guides which guide the peripheral edge of the filter unit which is positioned opposite thereto to let the filter unit slide on the guides into the interior of the cleaner case through the opening.

According to this configuration, the filter unit can be made to slide through the opening along the guides, so as to mount and dismount the filter unit to/from the cleaner case. This does not require any use of tool and only necessitates the sliding of the filter unit, which facilitates easy mounting and dismounting of the filter unit and, therefore, results in an enhanced maintainability. Further, it also obviates the need to provide means inside of the cleaner case to retain the filter unit. This means that, once the filter unit is removed, the interior of the cleaner case is exposed. Thus, upon dismounting of the filter unit, improved visibility of the interior and enhanced maintainability for cleaning purposes can be achieved.

The opening in the cleaner case can be provided in a small size, as long as it is sufficient to allow the filter unit to slide therethrough for mounting and dismounting purposes. This can consequently improve the air tightness of the cleaner case, thereby reducing the level of air intake noise escaping through the cleaner case and mitigating the ingress of dirt and water into the interior of the cleaner case.

Any combinations of at least two features disclosed in the claims and/or the specification and/or the drawings should also be construed as encompassed by the present disclosure. Especially, any combinations of two or more of the claims should also be construed as encompassed by the present disclosure.

### BRIEF DESCRIPTION OF THE DRAWINGS

The present disclosure will be more clearly understood from the following description of preferred embodiments made by referring to the accompanying drawings. However, the embodiments and the drawings are given merely for the purpose of illustration and explanation, and should not be used to delimit the scope of the present disclosure, which scope is to be delimited by the appended claims. In the accompanying drawings, alike numerals are assigned to and indicate alike parts throughout the different figures:

FIG. 1 shows a side view of a motorcycle equipped with an air cleaner, in accordance with a first embodiment of the present disclosure;

FIG. 2 shows an enlarged side view of the rear of the motorcycle;

FIG. 3 shows a side view similar to FIG. 2, in which a side cover has been partially removed;

FIG. 4 shows a side view of the air cleaner;

FIG. 5 shows a view of an inner surface of the side cover as seen from inside;

FIG. 6 shows a perspective view of a filter unit;

FIG. 7 shows an exploded perspective view of the filter unit of the air cleaner;

FIG. 8 shows a longitudinal cross sectional view of the filter unit;

FIG. 9 shows a side view of a portion of interest of the air cleaner as seen from an inlet side of the filter unit in an attachment and detachment direction thereof;

FIG. 10 shows a perspective view of a guide of the air cleaner;

FIG. 11 shows a top view of the guide;

FIG. 12A shows a perspective view of one position of the filter unit being mounted to the air cleaner;

FIG. 12B shows a perspective view of another position of the filter unit being mounted to the air cleaner; and

FIG. 12C shows a perspective view of yet another position of the filter unit being mounted to the air cleaner.

### DESCRIPTION OF EMBODIMENTS

What follows is a description of preferred embodiments of the present disclosure made with reference to the drawings. The terms “front” and “forward” used herein refer to a side facing the direction of travel of a vehicle, whereas the terms “rear” and “rearward” used herein refer to a side facing a direction counter to the direction of travel of the vehicle. Thus, a longitudinal direction of the vehicle coincides with a “front-to-rear or rear-to-front direction.” Moreover, the terms “left” and “leftward” and the terms “right” and “rightward” used herein refer to sides facing the left and the right of the vehicle, respectively, as viewed from a driver seated in the vehicle. Accordingly, a left-to-right or right-to-left direction coincides with a widthwise direction of the vehicle. A “widthwise inside” refers to a side facing towards the longitudinally extending centerline of a vehicle body, whereas a “widthwise outside” refers to a side facing away from that centerline of the vehicle body.

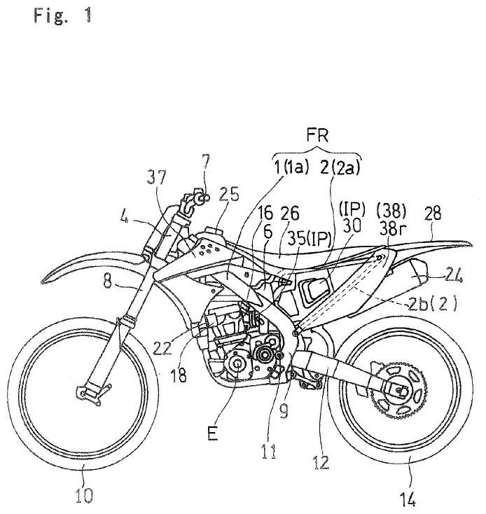

FIG. 1 shows a side view of a motorcycle equipped with an air cleaner, in accordance with a first embodiment of the present disclosure. The motorcycle in FIG. 1 is designed for off-road riding use. It should be noted, however, that a motorcycle designed for off-road riding use is one of non-limiting examples of a motorcycle according to the present disclosure.

The motorcycle includes a vehicle body frame FR. The vehicle body frame FR includes a main frame 1 and a rear frame 2 which form a front part and a rear part, respectively, of the vehicle body frame FR. The main frame 1 extends diagonally downwards from a front-end head pipe 4 towards the rear. In the instant embodiment, the main frame 1 includes a pair of main frames on the left and the right. The distance between the left and right main frames in a widthwise direction increases progressively towards the rear between the head pipe 4 and a central point of the main frames in a longitudinal direction, and remains generally constant from there on up to a rear end thereof. The left and right main frames are bridged at a portion of a rear part thereof with a cross frame 6 extending in a widthwise direction. Then, the main frame 1 is curved downwards from behind the cross frame 6 so as to extend in a generally downward direction.

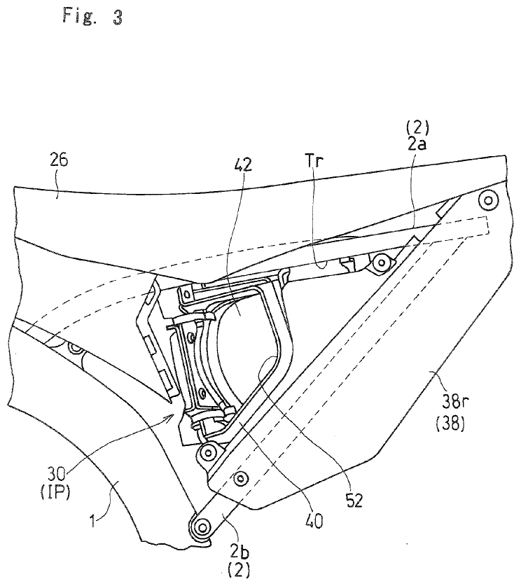

The rear frame 2 includes an upper rear frame piece 2a and a lower rear frame piece 2b. The upper rear frame piece 2a is coupled at a front end thereof to the cross frame 6 and extends rearwards from the cross frame 6. The lower rear frame piece 2b is coupled at a front end thereof to a lower part of the main frame 1. The lower rear frame piece 2b extends diagonally upwards from the main frame 1 towards the rear and is coupled at a rear end thereof to a rear part of the upper rear frame piece 2a. Thus, the main frame 1 and the upper and lower rear frame pieces 2a, 2b together define a triangle Tr (FIG. 3) when viewed from a side.

A front fork 8 is rotatably supported on a head pipe 4 through a steering shaft (not shown). A steering handle 7 is fixed to an upper end of the front fork 8. A front wheel 10 is mounted to a lower end of the front fork 8.

A swingarm bracket 9 is arranged at a lower end of a rear part of the main frame 1. Mounted to the swingarm bracket 9 is a pivot shaft 11 about which a swingarm 12 is supported so as to be swingable up and down. A rear wheel 14 is supported at a rear end of the swingarm 12.

An engine E serving as a power source for the motorcycle is located below and mounted to the main frame 1 in a forwardly facing fashion. The engine E drives the rear wheel 14 via a power transmission member (not shown) such as a drive chain. While the engine E in the instant embodiment is a single-cylinder 4-cycle engine E, this is only one of non-limiting examples of the design of the engine E.

The engine E has a rear side on which an intake port 16 is formed and a front side on which an exhaust port 18 is formed. Air introduced through the intake port 16 is mixed with fuel to provide an air-fuel mixture that is combusted in a combustion chamber and exhausted through the exhaust port 18. An exhaust pipe 22 is coupled to the exhaust port 18. The exhaust pipe 22 extends on a right side of the engine E towards the rear and is coupled to an exhaust muffler 24 located on a right side of and above the rear wheel 14. It should be noted, however, that this is only one of non-limiting examples of arrangement of the exhaust pipe 22 and the exhaust muffler 24.

A fuel tank 25 is supported on the main frame 1. Fuel for the engine E can be stored in the fuel tank 25. The fuel tank 25 is located above the engine E. Present rearwards of the fuel tank 25 is a seat 26 which is supported on the upper rear frame piece 2a. A rear fender 28 is located rearwards of the seat 26 and above the exhaust muffler 24. The rear fender 28 keeps off jumping small rocks, dirt, water, etc. that are splashed up by the rear wheel 14.

An air cleaner 30 is located rearwards of the engine E and below the seat 26. The air cleaner 30 filters and purifies externally introduced air. Air purified by the air cleaner 30 is supplied to the intake port 16 of the engine E. The details of the air cleaner 30 will be discussed later.

Positioned between the air cleaner 30 and the intake port 16 of the engine E is a fuel supply device 35 which feeds fuel to the engine E. In the instant embodiment, a throttle body with a fuel injector is used for the fuel supply device 35. It should be noted, however, that this is only one of non-limiting examples of the fuel supply device 35. For example, it may alternatively comprise a carburetor. In this manner, the air cleaner device 30 and the fuel supply device 35 together form an intake passage IP for supplying intake air to the intake port 16 of the engine E.

A pair of shrouds 37 on the left and the right are arranged at a front part of the vehicle body. The shrouds 37 cover the space, which is located in front of the fuel tank 25 and the engine E, laterally from outside. In addition, a pair of side covers 38 on the left and the right are arranged rearwards of the shrouds 37 and below a rear part of the seat 26. The side covers 38 cover the lower rear frame piece 2b, the air cleaner 30, and a front part of the exhaust muffler 24 laterally from outside.

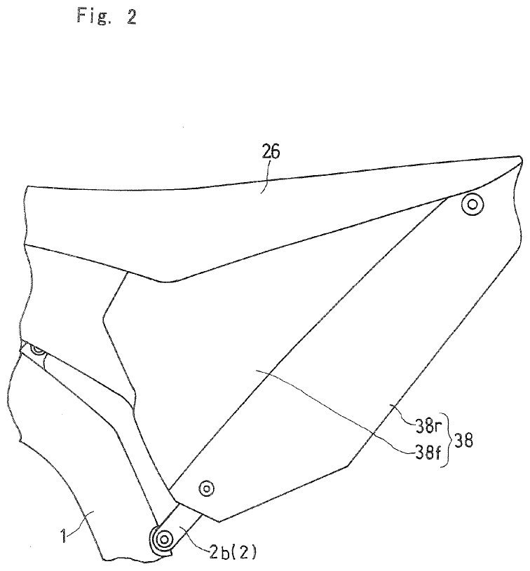

Each of the side covers 38 includes a side cover front 38f and a side cover rear 38r which form a front part and a rear part, respectively, of the corresponding side cover 38 as shown in FIG. 2. FIG. 2 depicts a state in which the side cover front 38f is mounted in position, whereas FIG. 3 depicts a state in which the side cover front 38f has been removed. Turning to FIG. 2, the side cover rear 38r covers the lower rear frame piece 2b and a front part of the exhaust muffler 24 (FIG. 1) laterally from outside. The side cover front 38f covers the air cleaner 30 laterally from outside. More specifically, the side cover front 38f covers a large part of a space, which is defined by the aforementioned triangle Tr formed by the vehicle body frame FR shown in FIG. 1, laterally from outside.

The side cover rear 38r is removably mounted to the vehicle body frame FR with fasteners such as a bolt. The side cover front 38f is removably mounted to the side cover rear 38r and a corresponding one of the shrouds 37 through insertion, locking engagement, or the like. Thus, the side cover front 38f can be manually mounted and dismounted without any use of tool.

### [Air Cleaner]

Now, the details of the air cleaner 30 will be described. In the following discussion, the terms “upstream” and “downstream” refer to an upstream side and a downstream side, respectively, along the direction of air flow.

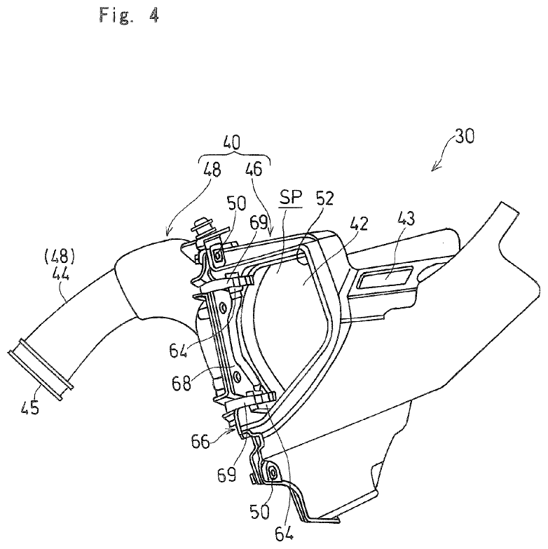

As illustrated in FIG. 4, the air cleaner 30 includes a cleaner case 40, a filter unit 42, and a duct 44. The cleaner case 40 is configured as a box that forms the outer shell of the air cleaner 30 and has an interior that defines a volume SP (which will hereinafter be referred to as an “internal volume SP”) in which air can be filled. The filter unit 42 is positioned in the internal volume SP inside the cleaner case 40 to filter air that passes therethrough. The upstream side of the filter unit 42 in the internal volume SP is defined as a dirty chamber, whereas the downstream side of the filter unit 42 in the internal volume SP is defined as a clean chamber. The details of the filter unit 42 will be discussed later.

The cleaner case 40 includes a first case 46 and a second case 48. The first case 46 and the second case 48 are coupled with several fasteners 50. In the instant embodiment, the first case 46 forms a rear part of the cleaner case 40, whereas the second case 48 forms a front part of the cleaner case 40. The filter unit 42 is arranged at the interface between the first case 46 and the second case 48. Thus, the interior of the first case 46 defines the dirty chamber, whereas the interior of the second case 48 defines the clean chamber.

The first case 46 has an air introducing port 43 formed therein. The introducing port 43 is formed in the top surface of a rear part of the first case 46 and is open towards the top. It should be noted, however, that this is only one of non-limiting examples of the location of the air introducing port 43.

The first case 46 has an opening 52 which is defined in and is open to one of widthwise opposite sides thereof. The opening 52 in the instant embodiment is defined in and is open to the left side of the first case 46. Preferably, the opening 52 is open to a side which faces away from the exhaust muffler 24 (FIG. 1). The opening 52 is oriented towards the space Tr which is defined by the triangle formed by the vehicle body frame FR in a manner shown in FIG. 3. Thus, the opening 52 of the air cleaner 30 is covered laterally from outside by a corresponding one of the side covers 38. In the instant embodiment, the opening 52 of the air cleaner 30 is covered laterally from outside by the side cover front 38f.

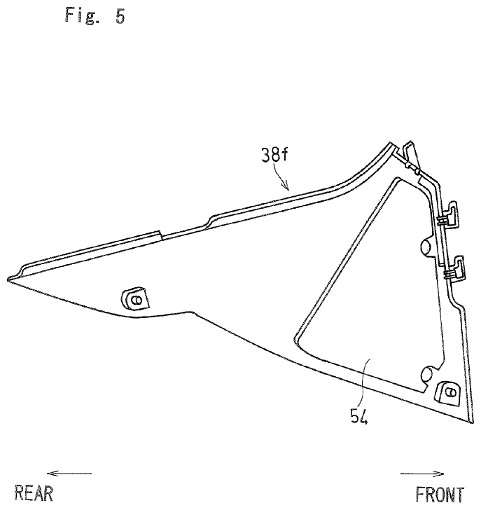

As illustrated in FIG. 5, the side cover front 38f in the instant embodiment has an inner side surface with a seal member 54 which is mounted thereon and has a shape conforming to the opening 52 (FIG. 4). This can improve the air tightness of the cleaner case 40. Consequently, the level of air intake noise escaping through the opening 52 can be suppressed, while also preventing possible ingress of dirt, water, etc. through the opening 52. The seal member 54 is made of a synthetic sponge, for example. It should be noted, however, that this is only one of non-limiting examples of material of the seal member 54. Moreover, the seal member 54 may be omitted.

The opening 52 shown in FIG. 4 allows the mounting and dismounting of the filter unit 42 therethrough. Thus, the interior volume SP of the cleaner case 40 can be accessed from the left through the opening 52 for the mounting and dismounting of the filter unit 42 thereto/therefrom. The features used to mount and dismount the filter unit 42 will be discussed later.

In the instant embodiment, the air introducing port 43 and the opening 52 used for the mounting and dismounting of the filter unit 42 are provided as separate elements. Alternatively, the opening 52 may be used to introduce air and concurrently allow the mounting and dismounting of the filter unit 42. In other words, the opening 52 may introduce air into the interior of the cleaner case 40 therethrough and may also allow the mounting and dismounting of the filter unit 42 in the interior volume SP of the cleaner case 40 therethrough from the left.

The duct 44 is formed of cylindrical pipe segments. The duct 44 is coupled at an upstream end thereof to a front end of the cleaner case 40. More specifically, the duct 44 is coupled at an upstream end thereof to the second case 48 of the cleaner case 40. Meanwhile, the duct 44 is coupled at a downstream end thereof to the fuel supply device 35 (FIG. 1). Thus, the downstream end of the duct 44 forms a delivery port 45 of the air cleaner 30. The duct 44 in the instant embodiment is formed as an inseparable one piece with the second case 48 of the cleaner case 40. Alternatively, the duct 44 and the second case 48 may be provided as distinct pieces that are coupled with fasteners such as a bolt.

Air introduced into the interior volume SP from the introducing port 43 at a rear part of the cleaner case 40 flows forwards and passes through the filter unit 42 where it gets purified. Purified air flows forwards in the interior volume SP and is delivered out of the delivery port 45 so that it is supplied as intake air to the engine E.

### [Filter Unit 42]

Now, the filter unit 42 in the instant embodiment will be described. As discussed earlier, the filter unit 42 is mounted to and dismounted from the interior volume SP of the cleaner case 40 from the left. In the following discussion, the term “attachment direction” refers to a direction of the mounting of the filter unit 42 and can be defined as a direction oriented from the opening 52 towards the interior volume SP of the cleaner case 40. Meanwhile, the term “detachment direction” refers to a direction counter to the attachment direction—i.e., a direction of the dismounting of the filter unit 42 from the interior volume SP—and can be defined as a direction oriented from the interior volume SP of the cleaner case 40 towards the opening 52. In the instant embodiment, the attachment direction and the detachment direction coincide with a widthwise direction (or a left-to-right or right-to-left direction), with the attachment direction pointing towards the right and the detachment direction pointing towards the left.

Further, the attachment direction and the detachment direction may sometimes be referred to as an “attachment and detachment direction”. A side facing in the attachment direction is referred to as a “closed side” in the attachment and detachment direction, whereas a side facing in the detachment direction is referred to as an “inlet side” in the attachment and detachment direction. Thus, in the instant embodiment, the inlet side and the closed side correspond to the left and the right, respectively, in the attachment and detachment direction.

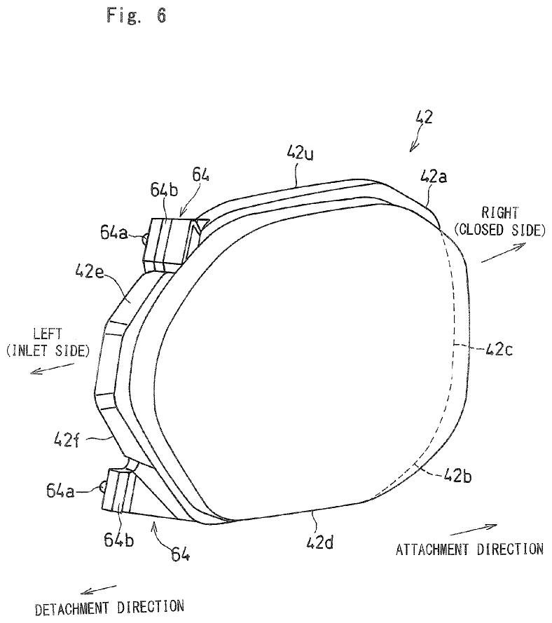

As illustrated in FIG. 6, the filter unit 42 has a pair of upper and lower peripheral edge sections 42u, 42d that extend in a widthwise direction. In an incorporated state to the vehicle body, the upper peripheral edge section 42u and the lower peripheral edge section 42d extend parallel to and spaced apart from each other in a vertical direction.

The filter unit 42 also has a first closed-side slope portion 42a which is sloped downwards from a closed-side end of the upper peripheral edge section 42u in an attachment direction and a second closed-side slope portion 42b which is sloped upwards from a closed-side end of the lower peripheral edge section 42d in an attachment direction. Thus, closed-side portions of a pair of peripheral edges 42u, 42d of the filter unit 42 are sloped towards each other in an attachment direction. A closed-side end of the first closed-side slope portion 42a and a distal end of the second closed-side slope portion 42b are joined to each other with a joining section 42c that extends in a vertical direction.

The filter unit 42 also has a first inlet-side slope portion 42e which is sloped downwards from an inlet-side end of the upper peripheral edge section 42u in a detachment direction and a second inlet-side slope portion 42f which is sloped upwards from a inlet-side end of the lower peripheral edge section 42d in a detachment direction. An inlet-side end of the first inlet-side slope portion 42e and an inlet-side end of the second inlet-side slope portion 42f are smoothly joined to each other.

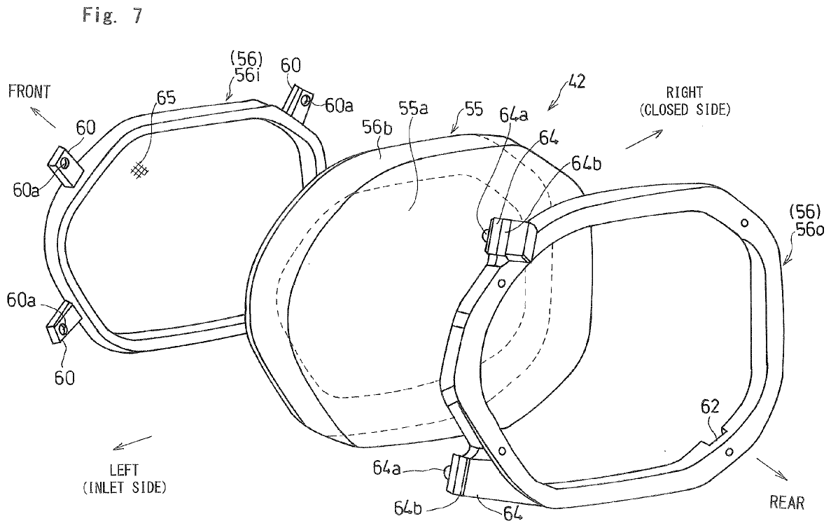

As illustrated in FIG. 7, the filter unit 42 includes an element 55 that filters intake air therethrough and holders 56 that hold the element 55 in place. In the instant embodiment, the element 55 and the holders 56 have similar external shapes. For example, the element 55 comprises a synthetic sponge made of a synthetic resin such as a polyurethane. It should be noted, however, that this is only one of non-limiting examples of the element 55.

The holders 56 comprise a pair of holders and clamp the element 55 in a thickness direction of the filter unit 42. More specifically, the holders 56 include an inner holder 56i and an outer holder 560 which together clamp the element 55 in a thickness direction. The term “thickness direction” used herein refers to a direction in which air passes through the filter unit 42. Thus, in the instant embodiment, a thickness direction coincides with a longitudinal direction of the vehicle.

The element 55 includes a main body segment 55a through which air passes and a holdable segment 55b formed at the periphery of the main body segment 55a. The main body segment 55a is configured as a planar segment having a thickness in a thickness direction in which air passes.

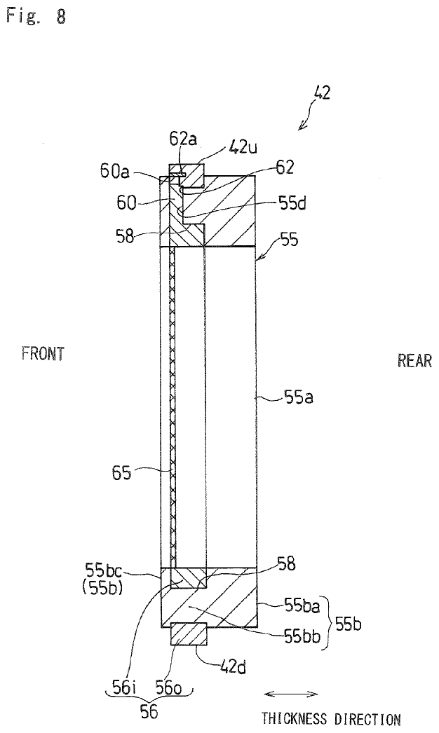

The holdable segment 55b is a segment which can be clamped by the holders 56 and is formed on the entire periphery of the main body segment 55a. As illustrated in FIG. 8, the holdable segment 55b includes a first portion 55ba adjoining the main body segment 55a and a cylindrical second portion 55bb projecting from the first portion 55ba on a downstream side (which is, in the instant embodiment, a front side) thereof in the direction of flow.

The first portion 55ba has an outer diameter surface that is located radially outwards of an outer diameter surface of the second portion 55bb. A third portion 55bc protruding radially inwards is formed on a leading end, i.e., a front end, of the second portion 55bb. The first portion 55ba, the second portion 55bb, and the third portion 55bc together form a receptacle 58 that is open to a radially inner side thereof to define a U-shaped cross section.

As illustrated in FIG. 7, the inner holder 56i comprises an annular member having a shape that conforms to the contour of the element 55. The inner holder 56i is provided with a mounting piece 60 that projects radially outwards from an outer peripheral surface of the inner holder 56i. In the instant embodiment, the mounting piece 60 includes four mounting pieces that are distributed in a spaced manner on the outer periphery of the inner holder 56i. In FIG. 7, only three of such mounting pieces are visible. It should be noted, however, that the mounting piece 60 can comprise any number of mounting pieces in a non-limiting manner. Each of such mounting pieces 60 has an engagement hole 60a formed therein.

The inner holder 56i has a front end face (or a downstream end face) with a flame arrester 65 mounted thereto. The flame arrester 65 prevents possible backfire from the engine E. In the instant embodiment, a stainless mesh (or meshed wire) is used for the flame arrester 65. Thus, the flame arrester (or wired mesh) 65 is arranged in the path of air. In this way, possible backfire from the engine E can be prevented while allowing air to be directed into the engine E. It should be noted, however, that this is only one of non-limiting embodiments of the location of the flame arrester 65.

The outer holder 560 also comprises an annular member having a shape that conforms to the contour of the element 55. The outer holder 560 has a similar shape to that of the inner holder 56i, but has an outer diameter larger than that of the inner holder 56i. The outer holder 560 has a front face formed therein with a first recess 62 which is set back in a rearward direction at a position corresponding to that of the mounting piece 60. The first recess 62 has a first engagement protrusion 62a formed thereon in a forwardly protruding manner at a position corresponding to that of the engagement hole 60a. The first recess 62 and the first engagement protrusion 62a formed are present in the same number as those of the mounting piece 60 and the engagement hole 60a—that is, four—respectively.

The outer holder 560 is provided with a retaining piece 64 that projects radially outwards from an outer peripheral surface of the outer holder 560. In the instant embodiment, the retaining piece 64 comprises two retaining pieces that are provided in a spaced manner in a vertical direction on a left side of the outer holder 560. It should be noted, however, that the retaining piece 64 can comprise any number of retaining pieces in a non-limiting manner. Each of such retaining pieces has a forwardly oriented face with a second engagement protrusion 64a formed thereon in a forwardly protruding manner. Further, each of such retaining pieces 64 has a rearwardly oriented face formed thereon with a step 64b which is set back in a forward direction.

Now, the features that constitute an assembly of the filter unit 42 will be described. The inner holder 56i is fitted into the receptacle 58 in the element 55. The outer diameter surface of the inner holder 56i, in this position, is in close or direct contact with the inner diameter surface of the second portion 55bb of the element 55. Also, the mounting piece 60 on the inner holder 56i projects radially outwards through a cut 55d formed in the second portion 55bb of the element 55.

Then, the outer holder 560 is assembled onto the element 55. The inner diameter surface of the outer holder 560, in this position, is in direct contact with the outer diameter surface of the second portion 55bb of the element 55. The inner diameter surface of the outer holder 560 may at least partially be in direct contact with the outer diameter surface of the first portion 55ba of the element 55. In other words, the element 55 is fitted to the inner diameter area of the outer holder 560 having an annular shape.

The mounting piece 60 on the inner holder 56i is brought into engagement with the first recess 62 in the outer holder 560, while the first engagement protrusion 62a of the outer holder 560 is inserted into the engagement hole 60a in the mounting piece 60 on the inner holder 56i. In this way, the element 55 is clamped between the inner holder 56i and the outer holder 560.

The holders 56 and the element 55 are thus integrated and forms an assembly of the filter unit 42. In the instant embodiment, as illustrated in FIG. 8, the outer diameter surface of the outer holder 560 forms the outermost surface of the filter unit 42. Thus, an upper edge of the outer holder 560 forms the upper peripheral edge section 42u of the filter unit 42, whereas a lower edge of the outer holder 560 forms the lower peripheral edge section 42d of the filter unit 42.

Such a configuration makes it possible to replace only the element 55 during a maintenance operation and leave the holders 56 in place for reuse. Further, the dismounting of the element 55 from the holders 56 and the mounting of the element 55 to the holders 56 can be manually performed without involving any use of tool.

As illustrated in FIG. 4, the air cleaner 30 also includes a guide 66 that provides for the guiding of the filter unit 42. The guide 66 allows the filter unit 42 to slide thereon through the opening 52 of the cleaner case towards the interior volume SP and from the interior volume SP towards the opening 52.

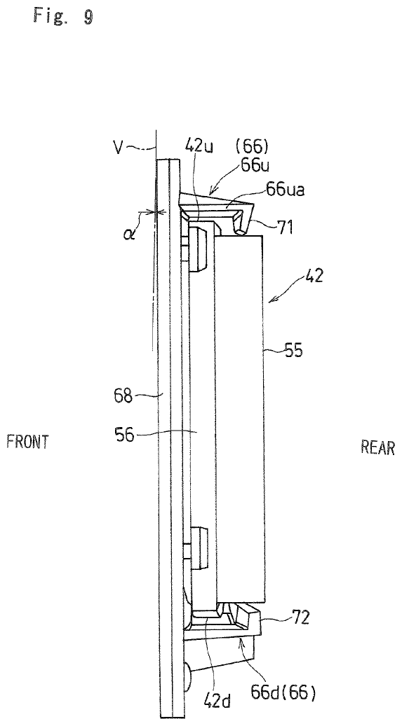

In the instant embodiment, as illustrated in FIG. 9, the guide 66 comprises a pair of upper and lower guides. Thus, the guide 66 includes an upper guide rail 66u and a lower guide rail 66d. The upper and lower guide rails 66u, 66d extend in an attachment and detachment direction. Thus, in the instant embodiment, the upper and lower guide rails 66u, 66d extend in a widthwise direction in a mounted state of the air cleaner 30 to the vehicle body. The upper guide rail 66u provides for the guiding of the upper peripheral edge section 42u (FIG. 8) of the filter unit 42, whereas the lower guide rail 66d provides for the guiding of the lower peripheral edge section 42d (FIG. 8) of the filter unit 42.

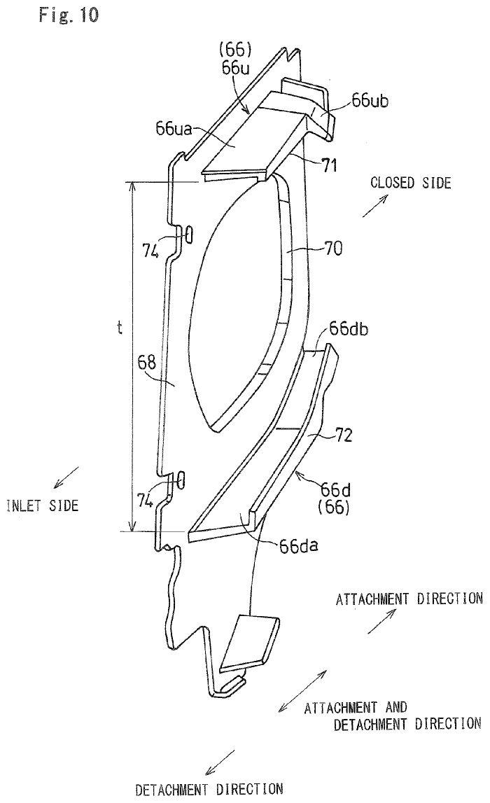

The upper guide rail 66u includes a planar, first guide section 66ua extending in an attachment and detachment direction. The first guide section 66ua has a planar shape with principal faces oriented in a vertical direction, one of which faces downwards and provides for the guiding of the upper peripheral edge section 42u of the filter unit 42. As illustrated in FIG. 10, the first guide section 66ua extends in an attachment and detachment direction so as to span from an inlet side, past a central point, and up to a point intermediate between the central point and a closed side of the interior volume SP of the cleaner case 40.

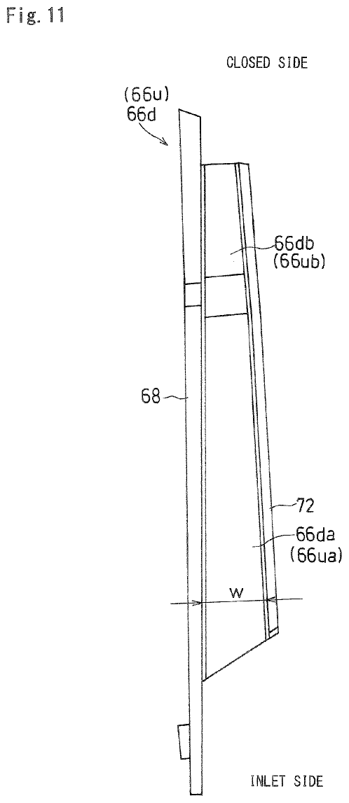

The upper guide rail 66u includes an upper guide slope portion 66ub extending diagonally downwards towards a closed side thereof from a closed side end of the first guide section 66ua. As illustrated in FIG. 11, the upper guide rail 66u has, in a thickness direction, a width w that decreases progressively in an attachment direction. In the instant embodiment, the width w decreases progressively from an inlet-side end of the first guide section 66ua to a closed-side end of the upper guide slope portion 66ub. Thus, the width w of the upper guide rail 66u has a largest value on an inlet side thereof and a smallest value on a closed side thereof. Note that the upper guide rail 66u and the lower guide rail 66d have similar general configurations. FIG. 11 representatively depicts the lower guide rail 66d.

The lower guide rail 66d shown in FIG. 10 includes a planar, second guide section 66da extending in an attachment and detachment direction. The second guide section 66da has a planar shape with principal faces oriented in a vertical direction, one of which faces upwards and provides for the guiding of the lower peripheral edge section 42d of the filter unit 42. The second guide section 66da also extends in an attachment and detachment direction so as to span from an inlet side, past a central point, and up to a point intermediate between the central point and a closed side of the interior volume SP of the cleaner case 40. The first guide section 66ua and the second guide section 66da extend parallel to each other.

As illustrated in FIG. 10, the lower guide rail 66d includes a lower guide slope portion 66db extending diagonally upwards towards a closed side thereof from a closed-side end of the second guide section 66da. Thus, closed-side portions of the upper guide rail 66d and the lower guide rail 66d are sloped towards each other in an attachment direction. Accordingly, the distance t in a vertical direction between the upper guide rail 66u and the lower guide rail 66d has a largest value on an inlet side thereof and a smallest value on a closed side thereof.

Just like the upper guide rail 66u, the lower guide rail 66d also has, in a thickness direction, a width w (FIG. 11) that decreases progressively in an attachment direction. More specifically, the width w decreases progressively from an inlet-side end of the second guide section 66da to a closed-side end of the lower guide slope portion 66db. Thus, the width w of the lower guide rail 66d has a largest value on an inlet side thereof and a smallest value on a closed side thereof.

### [Mounting of Air Cleaner]

As illustrated in FIG. 4, the air cleaner 30 includes a plate 68 which is interposed between the first case 46 and the second case 48 and on which the guide 66 is arranged. The plate 68 comprises a planar member made of a resin and is coupled to the first case 46 together with the second case 48 using the previously mentioned several fasteners 50. In the instant embodiment, the plate 68 and the guide 66 are formed as one piece in a die molding process using a resin.

More specifically, as illustrated in FIG. 9, the upper guide rail 66u and the lower guide rail 66d extend from the plate 68 towards an upstream side thereof, i.e., rearwards. The upper guide rail 66u has a rear end with a first projection 71 formed thereon in a downwardly projecting manner. Meanwhile, the lower guide rail 66d has a rear end with a second projection 72 formed thereon in an upwardly projecting manner. The plate 68, the first projection 71, and the second projection 72 together restrict the movement of the filter unit 42 in a front-to-rear or rear-to-front direction, thereby stabilizing the guiding performed by the guide 66.

The plate 68 may be inclined relative to the vertical axis V, in an assembled state of the air cleaner 30 to the vehicle body. More specifically, the plate 68 may be positioned in place to extend upwards in a forwardly inclined manner. For example, the plate 68 in the instant embodiment is inclined in a forward direction by an angle α relative to the vertical axis V.

As illustrated in FIG. 10, the plate 68 has an aperture 70 formed therein between the upper guide rail 66u and the lower guide rail 66d. More specifically, the aperture 70 is formed below the upper guide rail 66u and above the lower guide rail 66d. The aperture 70 provides a path through which air passes. The size and shape of the aperture 70 are generally comparable to those of the filter unit 42 (FIG. 8). Thus, in an installed position of the filter unit 42, the aperture 70 is closed by the filter unit 42, but serves to allow air filtered by the filter unit 42 to pass therethrough during the operation of the engine E. In a non-installed position of the filter unit 42, the aperture 70 is exposed and is visible through the opening 52.

The plate 68 has an engagement hole 74 which is formed therein at a position corresponding to that of the second engagement protrusion 64a on the filter unit 42. The engagement hole 72 comprises two engagement holes that are provided in a spaced manner in a vertical direction on an inlet side portion of the plate 68.

Further, as illustrated in FIG. 4, the plate 68 is provided with a retaining member 69 at a position corresponding to that of the retaining piece 64 on the filter unit 42. The retaining member 69 in the instant embodiment includes a clamp which is mounted pivotably about a vertical axis. The clamp 69 comprises a planer member exhibiting some elasticity and made of, for example, a metal. The retaining member 69 comprises two retaining members that are provided in a spaced manner in a vertical direction on an inlet side portion of the plate 68.

Now, the features used to attachment and detachment the filter unit 42 will be described. In a maintenance operation for the air cleaner 30, the side cover front 38f shown in FIG. 2 is removed to expose the opening 52 of the air cleaner 30, as shown in FIG. 3. The attachment and detachment of the filter unit 42 are performed through the opening 52.

### [Attachment and Detachment of Filter Unit 42]

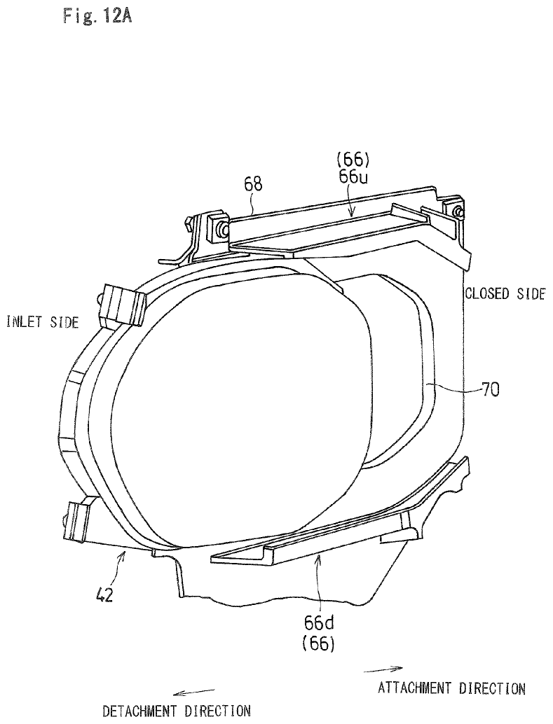

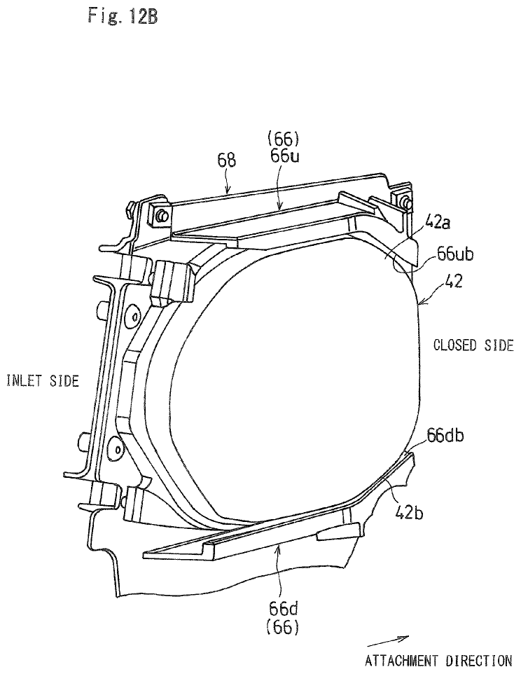

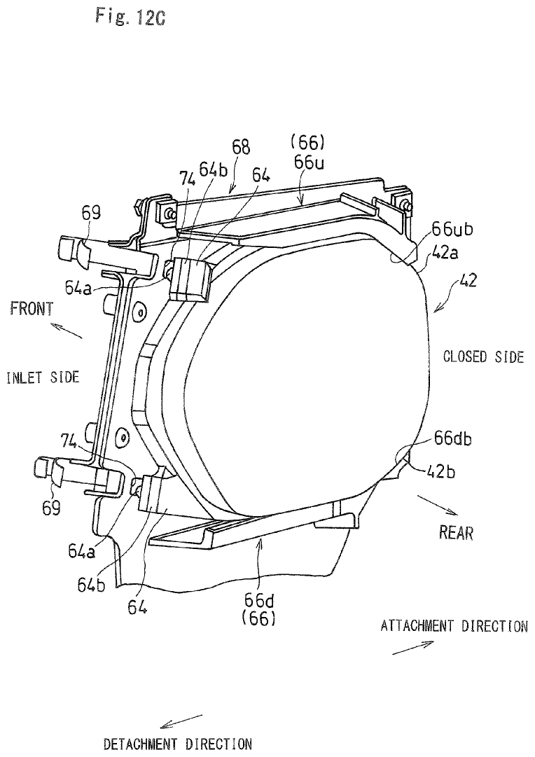

The mounting and dismounting procedures for the filter unit 42 will be described in connection with FIGS. 12A, 12B, and 12C. Firstly, the mounting procedure will be discussed. As illustrated in FIG. 12A, a closed side portion of the filter unit 42 is inserted along the guide 66. Here, the filter unit 42 has a vertical dimension that reduces at the closed side portion thereof. In contrast, the width w (FIG. 11) of each of the guide rails 66u, 66d has a largest value on an inlet side thereof, and the distance t (FIG. 10) between the two guide rails 66u, 66d also has a largest value on a proximal side thereof. For this reason, the filter unit 42 can be easily inserted along the guide 66.

As illustrated in FIG. 12B, the filter unit 42 is made to slide in an attachment direction along the guide 66 and is inserted into the interior volume SP (FIG. 4) of the cleaner case 46. Here, the width w (FIG. 11) of each of the guide rails 66u, 66d decreases progressively from an inlet side towards a closed side thereof, and the plate 68 is inclined relative to the vertical axis (FIG. 9). For this reason, as the filter unit 42 is being inserted into a closed side thereof, the filter unit 42 is urged against the plate 68, thus, achieving an enhanced sealing performance.

Moreover, as the filter unit 42 is made to slide in an attachment direction, the first closed-side slope portion 42a and the second closed-side slope portion 42b of the filter unit 42 are guided along the upper guide slope portion 66ub and the lower guide slope portion 66db of the guide 66, respectively. Then, as illustrated in FIG. 12C, the first closed-side slope portion 42a and the second closed-side slope portion 42b come into abutment with the upper guide slope portion 66ub and the lower guide slope portion 66db, respectively. Thus, the upper guide slope portion 66ub and the lower guide slope portion 66db provide for not only the guiding but also the positioning of the filter unit 42 by serving as a stopper.

Further, since the upper guide slope portion 66ub and the lower guide slope portion 66db are sloped progressively towards each other in an attachment direction, a small force applied to the filter unit 42 can result in a larger force acting on the filter unit 42 thanks to a so-called wedge effect. Specifically, as the filter unit 42 is being pushed along the guide 66, a large force is generated on each of the guide rails 66u, 66d and acts in a way that urges the filter unit 42 against the guide rails 66u, 66d, thereby helping achieve an enhanced sealing performance.

The second engagement protrusion 64a on the filter unit 42 is inserted into and brought into engagement with the engagement hole 74 in the plate 68. In addition, the clamp 69 on the plate 68 is pivoted to the rear so as to fit onto and engage with the step 64d of the retaining piece 64 on the filter unit 42. In this way, the filter unit 42 is retained at an inlet side portion thereof on the plate 68. Thus, the retaining piece 64 on the filter unit 42 constitutes a retainer that retains the filter unit 42 on the cleaner case 46. FIG. 4 depicts the clamp 69 in an engaged position, while FIG. 12C depicts the clamp 69 in a disengaged position.

As discussed earlier, the width w (FIG. 11) of each of the guide rails 66u, 66d has a largest value on an inlet side thereof, and the distance t (FIG. 10) between the two guide rails 66u, 66d also has a largest value on an inlet side thereof. For this reason, the filter unit 42 can be easily inserted along the guide 66, but it is also associated with a risk of the occurrence of backlash on an inlet side of the filter unit 42 after the mounting of the same. In the instant embodiment, such an occurrence of backlash on an inlet side of the filter unit 42 after the mounting of the same can be prevented by the virtue of the fact that the inlet side of the filter unit 42 can be secured to the plate 68 through the insertion of the second engagement protrusion 64a and the gripping by the clamp 69. Thus, the instant embodiment can achieve both the ease of insertion and the post-mounting stability of the filter unit 42.

The dismounting procedure for the filter unit 42 proceeds in a reverse order from that of the mounting procedure. In particular, the clamp 69 is uncoupled from the retainer piece 64 on the filter unit 42, and the second engagement protrusion 64a on the filter unit 42 is disengaged from the engagement hole 74 in the plate 68. Further, the filter unit 42 is made to slide along the guide rails 66u, 66d in a detachment direction for removal. Thus, the instant embodiment can achieve both easy mounting and dismounting of the filter unit 42 without involving any use of tool.

According to the abovementioned configuration, the filter unit 42 can be made to slide through the opening 52 along the guide 66, so as to mount and dismount the filter unit 42 to/from the cleaner case 46. This does not require any use of tool and only necessitates the sliding of the filter unit 42, which facilitates easy mounting and dismounting of the filter unit 42 and, therefore, results in an enhanced maintainability. Further, it also obviates the need to provide means inside of the cleaner case 46 to retain the filter unit 42. This means that, once the filter unit 42 is removed, the interior of the cleaner case 42 is exposed. Thus, upon dismounting of the filter unit 42, improved visibility of the interior and enhanced maintainability for cleaning purposes can be achieved.

The opening 52 in the cleaner case 46 shown in FIG. 4 can be provided in a small size, as long as it is sufficient to allow the filter unit 42 to slide therethrough for mounting and dismounting purposes. This can consequently improve the air tightness of the cleaner case 46, thereby reducing the level of air intake noise escaping through the cleaner case 46 and mitigating the ingress of dirt and water into the interior of the cleaner case 46.

In the instant embodiment, as illustrated in FIG. 11, the width w of each of the guide rails 66u, 66d in a thickness direction decreases progressively in an attachment direction. This provides a large width w on an inlet side, thereby facilitating insertion and achieving easy attachment and detachment. It is narrowed on a closed side, thereby helping stabilize a post-mounting position.

In the instant embodiment, as illustrated in FIG. 10, closed-side portions of the upper and lower guide rails 66u, 66d are sloped towards each other in an attachment direction. Likewise, closed-side portions of the filter unit 42 which are located more distally of the upper peripheral edge section 42u and the lower peripheral edge section 42d, respectively, are sloped towards each other in an attachment direction. Thus, the distance between the two guide rails 66u, 66d is wider on an inlet side thereof, thereby facilitating the insertion of the filter unit 42 therebetween and achieving easy attachment and detachment. Moreover, the distance between the two guide rails 66u, 66d is narrower on a closed side thereof, thereby helping stabilize the post-mounting position of the filter unit 42. Furthermore, a closed-side portion of the guide 66 serves as a stopper, thereby facilitating the positioning of the filter unit 42.

In the instant embodiment, as illustrated in FIG. 4, the filter unit 42 includes a retainer 64 which is associated with an inlet side portion thereof and retains the filter unit 42 on the cleaner case 46. As noted earlier, a wider inlet side facilitates insertion of the filter unit 42, but the drawback is that it is also associated with a risk of the occurrence of backlash on an inlet side of the filter unit 42 after the mounting of the same. According to the abovementioned configuration, however, the clamp 69 on the cleaner case 46 can retain the filter unit 42 at the retainer 64 on an inlet side portion of the filter unit 42, thereby helping stabilize the post-mounting position of the filter unit 42.

In the instant embodiment, as illustrated in FIG. 7, the filter unit 42 includes the element 55 that filters intake air, the pair of holders 56i, 560 that clamp the element 55 in a thickness direction of the filter unit 42, and the flame arrester 65 mounted to a clean-side holder 56i of those holders. In this way, the flame arrester 65 can be removed from the cleaner case 46 together with the filter unit 42, thereby helping achieve improved visibility of the interior of the cleaner case 46 and enhanced maintainability of the same for cleaning purposes.

In the instant embodiment, as illustrated in FIG. 3, the opening 52 is oriented towards a widthwise outside thereof and is covered laterally from outside by the side cover front 38f (FIG. 4) removably mounted to the vehicle body. In this way, only the side cover front 38f needs to be removed to replace the filter unit 42, thus, resulting in advantageous maintainability. In addition, the side cover front 38f can be manually mounted and dismounted without involving any use of tool, thereby resulting in even more advantageous maintainability.

In the instant embodiment, as illustrated in FIG. 5, the side cover front 38f has an inner surface side with the seal member 54 mounted thereon and having a shape conforming to the opening 52. In this way, the ingress of dirt and water through opening 52 can be mitigated. This is especially preferable for a vehicle which is designed for off-road riding use and travels on unprepared terrains like the one in the instant embodiment, since it is associated with a greater risk of the ingress of dirt and water.

The foregoing embodiments are only some of non-limiting examples according to the present disclosure. Numerous additions, modifications, or omissions can be made therein without departing from the principle of the present disclosure. For instance, while replacement of the filter unit in the preceding embodiments takes place in a widthwise direction, replacement of the filter unit may take place in a vertical direction for an alternative vehicle for which it is used. An air cleaner 30 according to the present disclosure can be advantageously used in a motorcycle which is designed for off-road riding use and requires frequent replacement of the element 42. However, an air cleaner 30 according to the present disclosure can also be applied to motorcycles not designed for off-road riding use. Accordingly, such variants are also encompassed within the scope of the present disclosure.

What is claimed is:

1. An air cleaner which filters intake air to be supplied to an engine of a motorcycle, the air cleaner comprising:
a cleaner case having an interior and having an opening defined therein;
a filter unit which filters intake air therethrough, the filter unit having a peripheral edge and being detachably mounted to the cleaner case; and
a pair of guides which guides the peripheral edge of the filter unit which is positioned opposite thereto to let the filter unit slide on the guides into the interior of the cleaner case through the opening.

2. The air cleaner as claimed in claim 1, wherein the guides have a width in a thickness direction of the filter unit, the width decreasing progressively in an attachment direction of the filter unit.

3. The air cleaner as claimed in claim 1, wherein at least closed side portions of the pair of guides are sloped towards each other in the attachment direction.

4. The air cleaner as claimed in claim 3, wherein the peripheral edge of the filter unit comprises a pair of peripheral edges, distal portions of which are sloped towards each other in the attachment direction.

5. The air cleaner as claimed in claim 1, further comprising:
a retainer which is associated with an inlet side of the filter unit and retains the filter unit on the cleaner case.

6. The air cleaner as claimed in claim 1, wherein the filter unit includes: an element which filters intake air therethrough; a pair of holders which clamp the element in a thickness direction of the filter unit; and a flame arrester mounted to a clean-side holder of the holders.

7. A motorcycle comprising an air cleaner as claimed in claim 1.

8. The motorcycle as claimed in claim 7, wherein the opening is oriented towards a widthwise outside thereof, the motorcycle further comprising:
a side cover, the side cover being removably mounted to a vehicle body thereof and covering the opening laterally from outside.

9. The motorcycle as claimed in claim 8, wherein the side cover has an inner surface with a seal member mounted thereon, the seal member having a shape conforming to the opening.
